(19) United States
(12) Patent Application Publication
(10) Pub. No.: US 2014/0328987 A1
(43) Pub. Date: Nov. 6, 2014

(54) Methods for Producing Scoop Shaped Pita Chips

(71) Applicant: Gregory Toufayan, Upper Saddle River, NJ (US)

(72) Inventor: Gregory Toufayan, Upper Saddle River, NJ (US)

(21) Appl. No.: 13/875,586

(22) Filed: May 2, 2013

(51) Int. Cl. A23L 1/164; A23P 1/14

(52) U.S. Cl. CPC A23L 1/164; A23P 1/14
USPC 426/497

(57) ABSTRACT

A method for forming pita chips in a conveyorized baking system is provided that includes forming dough into circular sheets having a diameter between about 1 inches to about 3 inches, and a thickness of about 1.5 mm to about 2.0 mm; proofing the circular sheets; baking the proofed circular sheets in a baking oven at a temperature above 500 degrees F. for a sufficient time to cause the proofed circular sheets to balloon and for upper and lower layers of the ballooned sheet to form into cupped shapes; splitting the upper layer from the lower layer to form a pair of cupped shaped pita halves; and toasting the pita halves for sufficient time to form scooped shaped pita chips.

### BACKGROUND

The present application is related to methods for producing snack foods and more particularly pita chips.

Pita chips have been produced for some time. Typically, pita chips are produced from a normal sized pita 6-8″ round that is cut into rectangular shapes, which results in generally flat and often irregularly shaped chips. This is problematic for the consumer in that these chips are not well suited to be used for scooping dip and shapes are limited to what can be done with slicing bread blades/cutters. Accordingly, there is a need for a method for producing pita chips that are not so limited.

### SUMMARY

In one aspect, a method for forming pita chips in a conveyorized baking system is provided that includes forming dough into circular sheets having a diameter between about 1 inches to about 3 inches, and a thickness of about 1.5 mm to about 2.0 mm; proofing the circular sheets; baking the proofed circular sheets in a baking oven at a temperature above 500 degrees F. for a sufficient time to cause the proofed circular sheets to balloon and for upper and lower layers of the ballooned sheet to form into cupped shapes; splitting the upper layer from the lower layer to form a pair of cupped shaped pita halves; and toasting the pita halves for sufficient time to form scooped shaped pita chips.

In one embodiment, the circular sheets are formed to have a diameter between about 2 inches to about 2.5 inches.

In one embodiment, the step of forming the circular sheets of dough comprises sheeting the dough into a continuous sheet of dough and pressing circular sheets out of the continuous sheet of dough.

In one embodiment, the step of forming the circular sheets of dough comprises extruding and cutting the dough into roughly shaped dough balls having a weight of between 10 grams and about 14 grams.

In one embodiment, the method further includes forming the roughly shaped dough into spherical dough balls and sheeting the dough balls.

In one embodiment, proofing comprises feeding the circular sheets into a multi-tiered proofer maintained at a temperature of between about 75° F. and about 95° F. and a humidity level of between about 45% and about 65%, for about 10 minutes to about 25 minutes.

In one embodiment, the circular sheets are baked from about 25 seconds to about 90 seconds.

In one embodiment, the method further includes spraying oil and applying seasoning on the pita chips.

In one embodiment, the oil and seasoning are applied before toasting the pita halves.

In one embodiment, the pita layers are split using a horizontal band slicer that is adjusted to slice the ballooned sheet at an intersection of the upper and lower layers.

In another aspect, a method for forming pita chips in a conveyorized baking system is provided that includes: forming dough into circular sheets having a diameter between about 2 inches to about 2.5 inches, and a thickness of about 1.5 mm to about 2.0 mm, wherein forming dough into circular sheets comprises sheeting the dough into a continuous sheet of dough and pressing circular sheets out of the continuous sheet of dough; proofing the circular sheets in a multi-tiered proofer maintained at a temperature of between about 75° F. and about 95° F. and a humidity level of between about 45% and about 65% for about 10 minutes to about 25 minutes; baking the proofed circular sheets in a baking oven at a temperature above 500 degrees F. for a sufficient time to cause the proofed circular sheets to balloon and for upper and lower layers of the ballooned sheet to form into cupped shapes; splitting the upper layer from the lower layer to form a pair of cupped shaped pita halves, wherein the pita layers are split using a horizontal band slicer that is adjusted to slice the ballooned sheet at an intersection of the upper and lower layers; and toasting the pita halves for sufficient time to form scooped shaped pita chips.

Additional aspects of the present invention will be apparent in view of the description which follows.

### BRIEF DESCRIPTION OF THE FIGURES

FIG. 1 is a flow diagram of a method for producing scooped shaped pita chips according to at least one embodiment.

FIG. 2 is a conveyorized baking system for producing scooped shaped pita chips according to at least one embodiment.

### DETAILED DESCRIPTION

The present application generally provides methods and for producing scooped shaped pita chips. In certain embodiments, the chips are created using conventional pita baking equipment. That is, the chips may be formed into scoop shapes without using an appropriately shaped blank. Moreover, the chips are not cut out from larger pitas. Instead, each chip is created from a single pita appropriately sized/shaped so that no cutting is required.

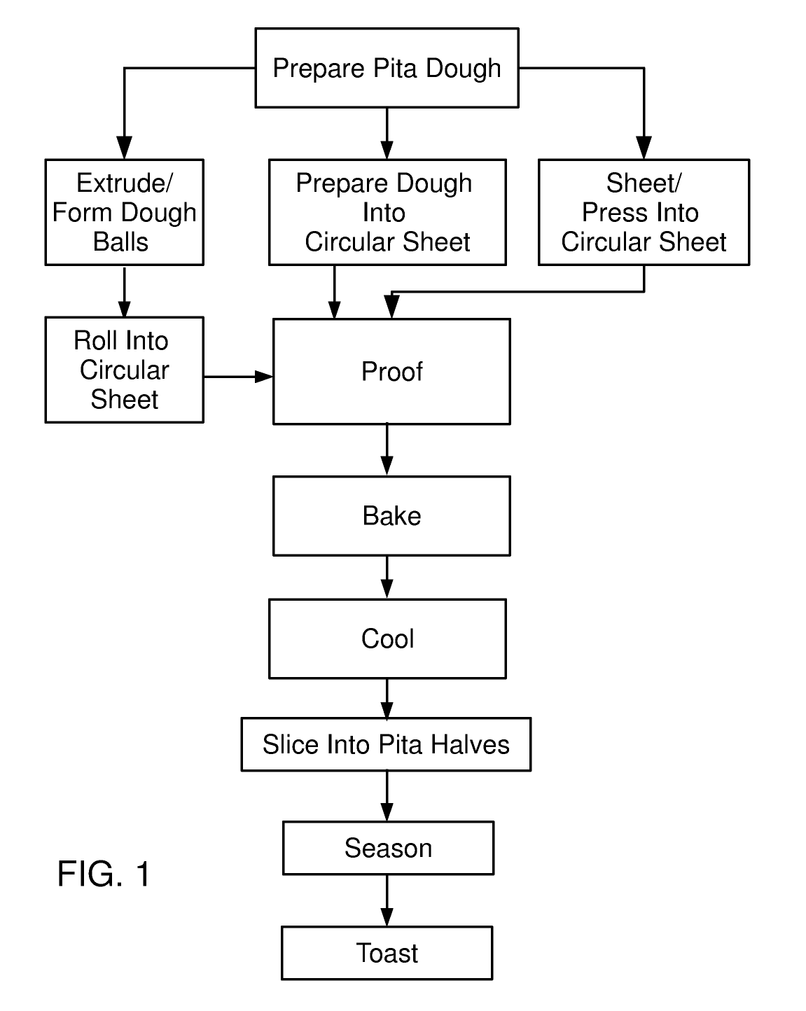

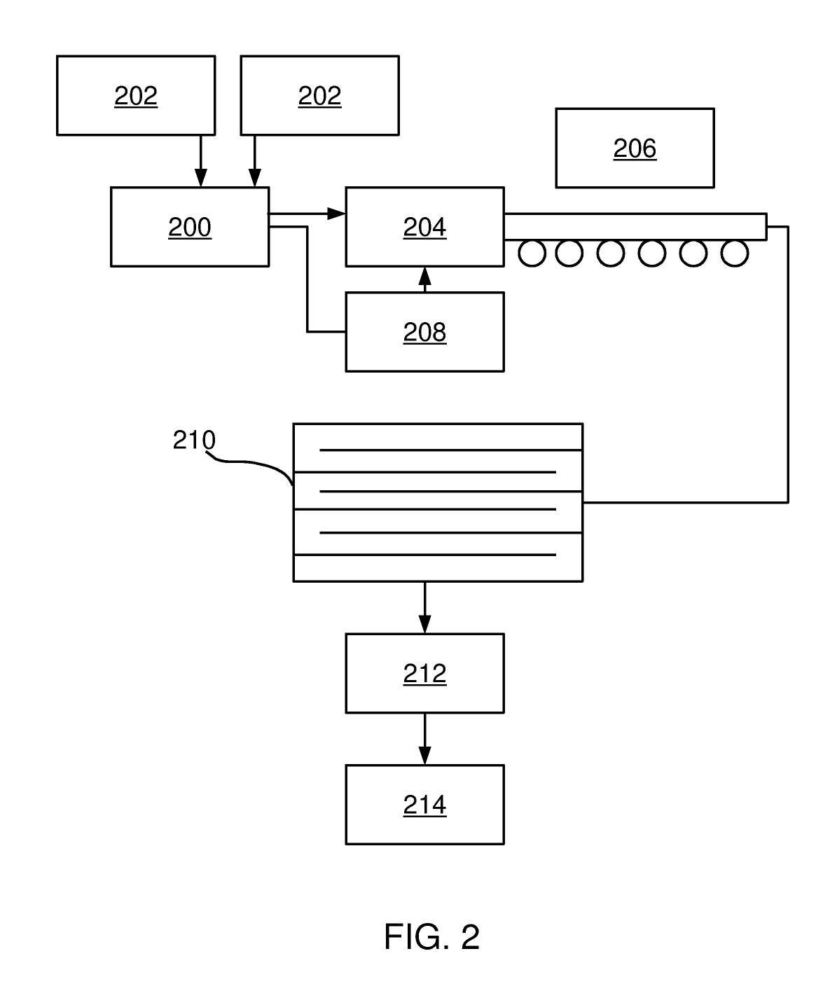

Referring to FIGS. 1 and 2, in at least one embodiment, the method of producing scooped shaped chips begins by preparing the pita dough at 102. The pita dough is generally a mixture that includes, inter alia, flour, salt, yeast, and water that is mixed until pliable. Mixing may be accomplished by hand or preferably with a mixing machine 200 that receives ingredients from one or more tanks 202. Once the dough is prepared, the dough is formed into appropriately sized sheets of dough at 104. In one embodiment, the sheets are circular in shape. It is understood that other shapes may also be formed in accordance with the process discussed herein, including oval, square, rectangular, triangular, etc. Moreover, the sheets may resemble animals or characters, such as fish and pigs. The sheets of dough may be formed in a variety of ways. Preferably, the sheets are formed by first sheeting the dough at 106 with a dough sheeter 204 to form a continuous sheet of dough having a thickness of about 1.5 mm to about 2.0 mm Thereafter, a dough press 206 is used to cut the circular or other desired shaped dough out of the continuous sheet of dough. Generally, the weight of the cut dough is are between about 10 grams and about 14 grams, or preferably about 12 grams. The dough press 206 preferably cuts circular shapes having a diameter of about 1 inch to about 3 inches, preferably of about 2 inches to about 2.5 inches, or more preferably of about 2.25 inches.

Alternatively, the circular sheets of dough may be formed by extruding and subsequently cutting the extruded dough at 108 into roughly shaped dough balls that when flattened result in a circular sheet having the dimensions noted above. Preferably, the dough balls are between about 10 grams and about 14 grams, or preferably about 12 grams. The roughly shaped balls may then be fed into a dough balling machine 208 that shapes the chunks into essentially spherical balls with a well-developed skin. The dough balls may then be fed through a sheeting machine 204 at 108 that passes rollers over the balls in two essentially perpendicular directions to flatten the balls into the desired circular shaped dough sheets.

The circular sheets of dough may then be fed into a conveyorized multi-tiered proofer 210 at 112. Preferably, the proofer 210 is maintained at a temperature of between 75° F. and 95° F. and a humidity level of between 45% and 65%, for about 10 minutes to about 25 minutes. Once proofed, the circular sheets may then be fed into a baking oven 212 for baking at 114 at a temperature of over 500° F. for a sufficient time to cause the planer surfaces of the circular sheet to sear on the outside and subsequently to cause the circular sheet to separate into layers and balloon as the steam within the pita expands. As the ballooned sheet continues to cook, the initially uncooked inside of the pita solidifies to lock in the balloon shape. That is, each of the upper and lower layers of the pita is form into a cupped shape. The baking occurs from about 25 seconds to about 90 seconds, depending on the dimensions of the pita.

After baking, the ballooned shaped pitas are cooled at 116 for about 20 minutes to about 40 minutes. Because of the relatively small size of the pitas, the pitas retain the ballooned shape after cooling. Once cooled, the ballooned pitas are then passed onto a horizontal band slicer 214 at 118 that is adjusted to slice the ballooned pitas at the seam, i.e., at the intersection of the upper and lower layers. Once split at 118, an individual pita will result in two concave pita halves. The pita halves may then be sprayed with oil and seasoned at 120, and then passed into a toasting or drying oven at 122. The drying oven is preferably set between 275° F. to about 375° F. and the pita halves are dried for about 7 minutes to about 20 minutes depending on the temperature and airflow in the drying oven. Alternatively, the oil and seasoning may be applied to the pita halves after drying.

While the foregoing has been described in some detail for purposes of clarity and understanding, it will be appreciated by one skilled in the art, from a reading of the disclosure, that various changes in form and detail can be made without departing from the true scope of the invention.

What is claimed is:

1. A method for forming pita chips in a conveyorized baking system, comprising:
forming dough into circular sheets having a diameter between about 1 inches to about 3 inches, and a thickness of about 1.5 mm to about 2.0 mm;
proofing the circular sheets;
baking the proofed circular sheets in a baking oven at a temperature above 500 degrees F. for a sufficient time to cause the proofed circular sheets to balloon and for upper and lower layers of the ballooned sheet to form into cupped shapes;
splitting the upper layer from the lower layer to form a pair of cupped shaped pita halves; and
toasting the pita halves for sufficient time to form scooped shaped pita chips.

2. The method of claim 1, wherein the circular sheets are formed to have a diameter between about 2 inches to about 2.5 inches.

3. The method of claim 1, wherein the step of forming the circular sheets of dough comprises sheeting the dough into a continuous sheet of dough and pressing circular sheets out of the continuous sheet of dough.

4. The method of claim 1, wherein the step of forming the circular sheets of dough comprises extruding and cutting the dough into roughly shaped dough balls having a weight of between 10 grams and about 14 grams.

5. The method of claim 4, further comprising forming the roughly shaped dough into spherical dough balls and sheeting the dough balls.

6. The method of claim 1, wherein proofing comprises feeding the circular sheets into a multi-tiered proofer maintained at a temperature of between about 75° F. and about 95° F. and a humidity level of between about 45% and about 65%, for about 10 minutes to about 25 minutes.

7. The method of claim 1, wherein the circular sheets are baked from about 25 seconds to about 90 seconds.

8. The method of claim 1, comprising spraying oil and applying seasoning on the pita chips.

9. The method of claim 8, wherein the oil and seasoning are applied before toasting the pita halves.

10. The method of claim 1, wherein the pita layers are split using a horizontal band slicer that is adjusted to slice the ballooned sheet at an intersection of the upper and lower layers.

11. A method for forming pita chips in a conveyorized baking system, comprising:
forming dough into circular sheets having a diameter between about 2 inches to about 2.5 inches, and a thickness of about 1.5 mm to about 2.0 mm, wherein forming dough into circular sheets comprises sheeting the dough into a continuous sheet of dough and pressing circular sheets out of the continuous sheet of dough;
proofing the circular sheets in a multi-tiered proofer maintained at a temperature of between about 75° F. and about 95° F. and a humidity level of between about 45% and about 65% for about 10 minutes to about 25 minutes;
baking the proofed circular sheets in a baking oven at a temperature above 500 degrees F. for a sufficient time to cause the proofed circular sheets to balloon and for upper and lower layers of the ballooned sheet to form into cupped shapes;
splitting the upper layer from the lower layer to form a pair of cupped shaped pita halves, wherein the pita layers are split using a horizontal band slicer that is adjusted to slice the ballooned sheet at an intersection of the upper and lower layers; and
toasting the pita halves for sufficient time to form scooped shaped pita chips.

12. The method of claim 11, wherein the circular sheets are baked from about 25 seconds to about 90 seconds.

13. The method of claim 11, comprising spraying oil and applying seasoning on the pita chips.

14. The method of claim 13, wherein the oil and seasoning are applied before toasting the pita halves.

15. A method for forming pita chips in a conveyorized baking system, comprising:
forming dough into sheets having a desired shape and a thickness of about 1.5 mm to about 2.0 mm;
proofing the sheets with the desired shape;
baking the proofed sheets in a baking oven at a temperature above 500 degrees F. for a sufficient time to cause the proofed sheets to balloon and for upper and lower layers of the ballooned sheet to form into cupped shapes;
splitting the upper layer from the lower layer to form a pair of cupped shaped pita halves; and
toasting the pita halves for sufficient time to form scooped shaped pita chips.

16. The method of claim 15, wherein the dough sheets in the desired shape have a weight of between 10 grams and about 14 grams.
